(19) United States
(12) Patent Application Publication
(10) Pub. No.: US 2023/0376500 A1
(43) Pub. Date: Nov. 23, 2023

(54) DISTRIBUTED DATA AND DIGITAL DELIVERY PLATFORM FOR INTEGRATED SUSTAINMENT AND MAINTENANCE

(71) Applicant: Raytheon Company, Waltham, MA (US)

(72) Inventors: Lauren Goff, Huntsville, AL (US); Nicholas W. Barrett, Oro Valley, AZ (US)

(21) Appl. No.: 18/318,502

(22) Filed: May 16, 2023

Related U.S. Application Data
(60) Provisional application No. 63/343,898, filed on May 19, 2022.

(51) Int. Cl. G06F 16/25; G06F 16/21; G06F 16/27

(52) U.S. Cl. CPC G06F 16/258; G06F 16/252; G06F 16/211; G06F 16/27

(57) ABSTRACT

A network includes a first node. The first node includes a data import service container, a system status condition database, and a distribution service container. The data import service container includes a first open interface and is configured to receive and organize data from the first open interface. The system status condition database is connected to the data import service container and includes memory for storing the data received and organized by the data import service container. The distribution service container is connected to the system status condition database and includes a second open interface for connecting the first node to a distribution service container of a second node of the network. The distribution service container of the first node is configured to synchronize the system status condition database of the first node with a system status condition database of the second node.

### CROSS-REFERENCE TO RELATED APPLICATION(S)

This application claims the benefit of U.S. Provisional Application No. 63/343,898 filed May 19, 2022, for “DISTRIBUTED DATA AND DIGITAL DELIVERY PLATFORM FOR INTEGRATED SUSTAINMENT AND MAINTENANCE” by L. Goff and N. Barrett.

### BACKGROUND

The present disclosure relates to data management, and in particular, to data management for sustaining and maintenance operations of distributed physical assets.

Sustaining operations and maintenance operations of distributed physical assets in the field and at base is important to the material availability, material reliability, ownership cost, and mean down time of the distributed physical assets. Accurate information regarding maintenance needs, maintenance trends, training efficacy, part availability, software updates, and other personnel and asset characteristics is important to inform and guide sustaining operations and maintenance operations. Collecting, trending, and verifying this information can be difficult and costly. Therefore, solutions to improve and streamline collection, verification, and analysis of this information is desired.

### SUMMARY

In one embodiment, a network includes a first node. The first node includes a data import service container, a system status condition database, and a distribution service container. The data import service container includes a first open interface and is configured to receive and organize data from the first open interface. The system status condition database is connected to the data import service container and includes memory for storing the data received and organized by the data import service container. The distribution service container is connected to the system status condition database and includes a second open interface for connecting the first node to a distribution service container of a second node of the network. The distribution service container of the first node is configured to synchronize the system status condition database of the first node with a system status condition database of the second node.

In another embodiment, a method for monitoring a physical asset includes collecting data on the physical asset via a sensor and directing the data across a first open interface of a data delivery platform device and into a data import service container of the data delivery platform device. The method further includes applying an adaption schema to the data in the data import service container and directing the data from the data import service container to a system status condition database of the data delivery platform device where the data is saved locally to memory in the data delivery platform device at the location of the physical asset.

In another embodiment, a system is disclosed that includes a first device. The first device includes a data import service container with a first open interface. The data import service container is configured to receive and organize data from the first open interface. The first device also includes a system status condition database connected to the data import service container. The system status condition database includes memory for storing the data received and organized by the data import service container. A distribution service container is connected to the system status condition database and includes a second open interface and a synchronization module configured to automatically share the data stored in the memory of the system status condition database across the second open interface. The first device also includes a condition data transformation service container connected to the system status condition database. The condition data transformation service container includes a third open interface.

### BRIEF DESCRIPTION OF THE DRAWINGS

FIG. 1 is a diagram of a network with nodes that include a distributed data and digital delivery platform.

FIG. 2A is a diagram of a system node of the network of FIG. 1 with the distributed data and digital delivery platform.

FIG. 2B is a diagram of another example of a system node of the network of FIG. 1 with the distributed data and digital delivery platform.

FIG. 3 is a diagram of the system node from FIG. 2B in communication with a logistics support node.

FIG. 4A is a diagram of a single system node operating in localized mode.

FIG. 4B is a diagram of a plurality of system nodes forming a distributed mesh.

FIG. 4C is a diagram of multiple meshes of system nodes in communication with a relay node to form a centralized mesh.

FIG. 5 is a diagram of another example of a system node in communication with a logistics support node.

FIG. 6 is a diagram of a relay node in communication with a logistics support node.

FIG. 7 is a diagram of a relay node in communication with system node.

FIG. 8 is a diagram of a logistics support node in communication with a first system node and a relay node, and a second system node in communication with the relay node.

### DETAILED DESCRIPTION

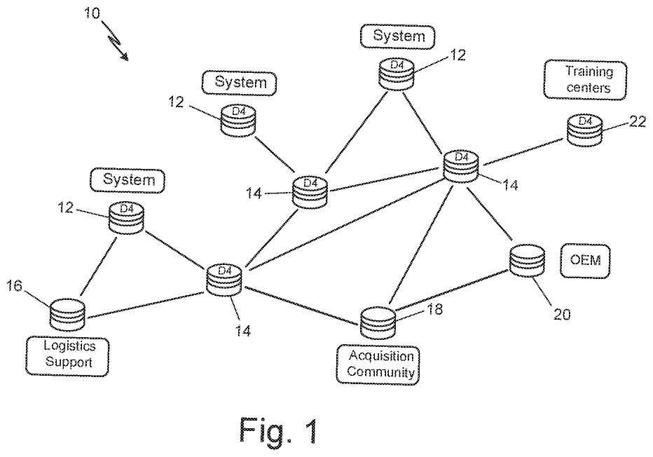

FIG. 1 is a diagram of a network 10 with nodes that include a distributed data and digital delivery platform, hereinafter referred to as “D4 platform”. Network 10 comprises system nodes 12, relay nodes 14, logistics support node 16, acquisition community node 18, original equipment manufacturer “OEM” node 20, and training center node 22.

In the embodiment illustrated in FIG. 1, there are three system nodes 12, three relay nodes 14, one logistics support node 16, one acquisition community node 18, one OEM node 20, and one training center node 22. In alternative embodiments, any number of system nodes 12, relay nodes 14, logistics support nodes 16, acquisition community nodes 18, OEM nodes 20, and training center nodes 22 can be connected to network 10. In the example of FIG. 1, system nodes 12 and relay nodes 14 include the D4 platform.

System nodes 12 form an edge of network 10. Each system node 12 can collect data from a physical asset such as a radar, a launcher, an aircraft, a ship, a ground vehicle, or any other stationary or deployable asset. Each system node 12 can operate independently or in coordination with network 10. Each system node 12 can be configured to perform data analysis operations locally of the physical asset connected to the respective system node 12. Each system node 12 can alternatively or in addition use the D4 platform to transmit data to a destination such as a different system node 12, logistics support node 16, acquisition community node 18, OEM node 20, and/or training center node 22 where the data can be stored and/or processed. After the data has been processed, the processed data can be sent back through network 10 to system node 12.

Relay nodes 14 will accept data from connected system nodes 12, logistics support node 16, acquisition community node 18, OEM node 20, and/or training center node 22 and will temporarily cache the data locally in a local storage device. After caching the data locally, relay nodes 14 will transmit and synchronize the data with connected system nodes 12, logistics support node 16, acquisition community node 18, OEM node 20, and/or training center node 22. Relay nodes 14 can store the data until the data is received by a connected system node 12, for a pre-determined period of time and/or until given instructions from a connected system node 12 to wipe the data from relay nodes 14. The instructions to wipe the data can be given in response to a breach in network 10, a hostile force capturing or approaching relay node 14, and/or routine clearings of all temporary data on network 10. Relay nodes 14 enable the data to be sent directly from system node 12 to system node 12 throughout network 10, thereby a need for a centralized infrastructure can be obviated. Relay nodes 14 can include mobile units, such as aerial or land drones, that include the D4 platform which allows relay node 14 to communicate with both system nodes 12 and nodes 16, 18, 20, and 22. By making relay nodes 14 mobile, network 10 can move position and adapt across geography as the deployed physical assets of system nodes 12 move and change position. Relay nodes 14 can also be carried or supported by a ground vehicle, an aerial vehicle, a ship, a space satellite, a computer in a fixed facility (such as a building or radio tower), or a person (such as a soldier equipped with portable communication hardware). Relay node 14 can be supported by any system or object used for electronic data communication that can carry and power the D4 platform at the location of relay node 14 without the need for human interfacing or persistent data storage.

Logistics support node 16 collects data from system nodes 12 through network 10 and stores that data to a local storage in logistics support node 16. Logistics support node 16 will compile the data from all system nodes 12 connected to network 10 to enable logistics support node 16 to coordinate all the deployed physical assets. Logistics support node 16 can utilize artificial intelligence, machine learning, trend analysis, and/or prognostics to compile and analyze the received data. Such coordination can include instructions to the deployed physical assets at system nodes 12 to alter position, trajectory, alertness level, or weapons status of the deployed assets. Logistics support node 16 communicates status information on the deployed physical assets to leaders to enable the leaders to make informed tactical decisions. Logistics support node 16 can be proximate to the deployed physical assets and system nodes 12, such as being in the same region or country. Alternatively, logistics support node 16 can be deployed far from the deployed physical assets and system nodes 12, such as being in a different country or continent.

Acquisition community node 18 functions similarly to logistics support node 16 in that acquisition community node 18 collects data from system nodes 12 of network 10 to a local storage in acquisition community node 18. Acquisition community node 18 uses the data from system nodes 12 to determine material and equipment that is needed by each physical asset at system nodes 12. Acquisition community node 18 can also provide information to network 10 regarding availability of material and equipment and lead times for supplying the material and equipment to the deployed physical assets at system nodes 12. Acquisition community node 18 can utilize artificial intelligence, machine learning, trend analysis, and/or prognostics to compile and analyze the received data from system nodes 12 and the information that acquisition community node 18 has regarding material and equipment availability. Logistics support node 16 can use the information from acquisition community node 18 to coordinate movement of material and equipment to system nodes 12, and/or can coordinate movement of a system node 12 to a location where the system node 12 can receive the equipment, material, and/or maintenance of the deployed physical asset.

OEM node 20 can also receive data from system nodes 12 through relay nodes 14 to a local storage in OEM node 20. OEM node 20 can perform condition logging, predictive maintenance, and administrative management of a deployed asset connected to one of system nodes 12. OEM node 20 can analyze the data stored in the local storage of OEM node 20 to determine the frequency of part replacement, rate of part degradation, and user habits. OEM node 20 can utilize artificial Intelligence, machine learning, trend analysis, and/or prognostics to analyze the received data. OEM node 20 can utilize the frequency of part replacement for each part to improve the part and reduce a replacement rate. OEM node 20 can utilize feedback from system nodes 12 to improve new iterations of the deployed assets. OEM node 20 can receive data from system node 12 indicating a current state of the deployed physical asset. The current state of the deployed asset can be indicative of an upcoming maintenance requirement. OEM node 20 can provide software updates, equipment data, and digital resources to system nodes 12. The digital resources can include training manuals, user guides, and system update information. The system updates provided by OEM node 20 to system nodes 12 can be performed during operation and utilization of the deployable asset.

Training center node 22 also receives data from system nodes 12 through relay nodes 14 to a local storage in training center node 22. Training center node 22 can utilize the data to conduct more accurate training simulations, communicate effective tactics based on real-world data, and/or improve technical manuals. Training centers 22 can utilize artificial intelligence, machine learning, trend analysis, and/or prognostics to compile and analyze the received data to determine the most effective data to train with. Training center node 22 can send training information and manuals to system nodes 12 for the particular physical assets at system nodes 12.

Since system nodes 12 are interoperable with relay nodes 14, logistics support node 16, acquisition community node 18, OEM node 20, and training center node 22, network 10 is independent of size and fully scalable. Since network 10 is independent of size and fully scalable, network 10 can contain any number of system nodes 12, relay nodes 14, logistics support nodes 16, acquisition community nodes 18, OEM nodes 20, and training center nodes 22. Network 10 can be platform-independent and abstracted from both hardware and operating system software through the use of open containers, compliant containers, and published web services for integration. As such, network 10 can run on legacy and/or new products produced by any provider.

The interfaces between system nodes 12, relay nodes 14, logistics support nodes 16, acquisition community nodes 18, OEM nodes 20, and training center nodes 22 are based on an open-architecture with published contracts, thus permitting integration of custom data providers and user-interface applications. As such, each manufacturer of physical assets for each system node 12 can provide additional software add-ons and programs that work in conjunction with the communication capabilities of the D4 platform of each system node 12.

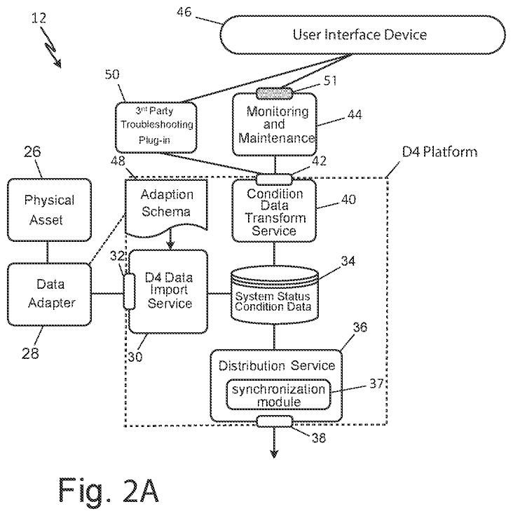

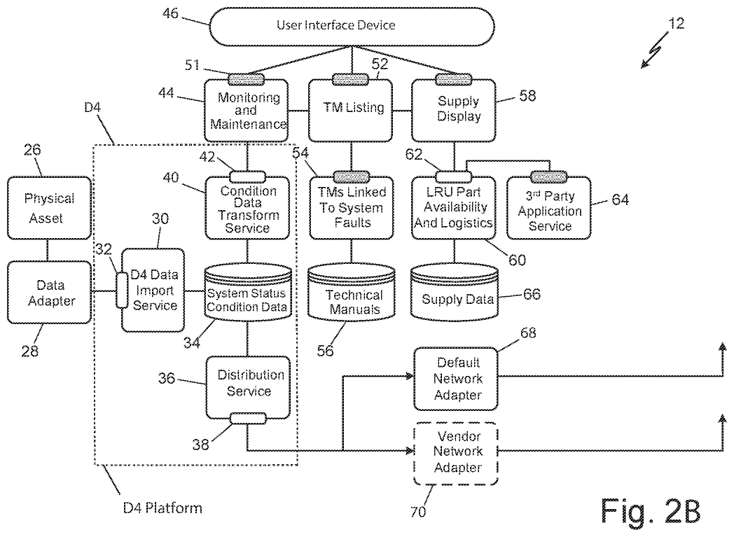

FIG. 2A is a diagram of system node 12 of network 10 with the D4 platform. System node 12 of FIG. 2A includes physical asset 26, data adapter 28, data import service container 30, first open interface 32, system status condition database 34, distribution service container 36 with synchronization module 37, second open interface 38, condition data transform service container 40, third open interface 42, monitoring and maintenance container 44, user interface device 46, adaptation schema 48, third-party troubleshooting plugin 50, and internal interface 51. The D4 platform is an integrated device that includes data import service container 30, first open interface 32, system status condition database 34, distribution service container 36, second open interface 38, condition data transform service container 40, and third open interface 42 within a single pod. At least each of system nodes 12 and relay nodes 14 of network 10 includes the D4 platform. As discussed below in detail, the D4 platform can be plugged into or wirelessly connected to physical asset 26 to form system node 12 for network 10 shown in FIG. 1. The D4 platform can also be plugged into or wirelessly connected to user interface device 46 and monitoring and maintenance container 44 to allow a technician and/or machine learning algorithm to analyze data regarding physical asset 26 at the site of system node 12.

Physical asset 26 can include a radar, a launcher, an aircraft, a ship, a ground vehicle, or any other physical asset of value that requires maintenance and monitoring. Physical asset 26 can be deployed to a remote location or physical asset 26 can be warehoused to await deployment. Physical asset 26 includes sensors that generate data regarding an operational status and condition of physical asset 26, position and movement of physical asset 26, arsenal of physical asset 26, and the environment surrounding physical asset 26. The data from the sensors of physical asset 26 is communicated to data adapter 28, and data adapter 28 communicates the data from the sensors of physical asset 26 to first open interface 32 of the D4 platform of system node 12. The data adapter 28 generally will acquire signals from physical hardware of physical asset 26 through layers of software and firmware that interact with the physical hardware of physical asset 26. Data adapter 28 can be built into physical asset 26 and/or data adapter 28 can be part of a cable or a wireless device that connects physical asset 26 to first open interface 32 of the D4 platform of system node 12. The wireless device can utilize radio frequency transmission, infrared transmission, Wi-Fi, and Bluetooth.

Data import service container 30 receives the data regarding physical asset 26 from data adapter 28 through first open interface 32. First open interface 32 can include a plug, port, and/or wireless receiver for communication with data adapter 28. Data import service container 30 is a software container that is executed by a processor (not shown) of the D4 platform to organize and format the data from the sensors of physical asset 26 to a format that is compatible with an application programming interface (API) of first open interface 32 and the D4 platform. Data import service container 30 ensures that the data received into the D4 platform is in a compatible format throughout network 10. The API of first open interface 32 of the D4 platform can be a published API such as RESTful and/or JSON. Vendors who produce physical asset 26 and desire to make physical asset 26 compatible with network 10 can use the API for first open interface 32 to generate adaption schema 48 for data adapter 28. Data adapter 28 can communicate adaption schema 48 to data import service container 30 once data adapter 28 is in communication with first open interface 32. Adaption schema 48 is software provided by the vendor of physical asset 26 that specifically aids data import service container 30 in reading, formatting, and/or reformatting the data from the sensors of physical asset 26 to a format that is compatible with the API of the D4 platform. Data import service container 30 also organizes the data received through first open interface 32 for storage in system status condition database 34. As part of formatting the data received through first open interface 32 for storage in system status condition database 34, data import service container 30 can encrypt the data. Data import service container 30 standardizes the format of the data received from the sensors of physical asset 26 such that the data can be shared at every node of network 10 that includes the D4 platform, even if network 10 includes physical assets 26 from different vendors that use different software platforms for gathering sensor data.

System status condition database 34 stores information within the D4 platform at system node 12 during operation. System status condition database 34, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). System status condition database 34 can include volatile and non-volatile computer-readable memories. Examples of volatile memories can include random access memories (RAM), dynamic random access memories (DRAM), static random access memories (SRAM), and other forms of volatile memories. Examples of non-volatile memories can include, e.g., magnetic hard discs, optical discs, flash memories, or forms of electrically programmable memories (EPROM) or electrically erasable and programmable (EEPROM) memories. System status condition database 34 receives the data regarding physical asset 26 from data import service container 30 and stores the data regarding the physical asset 26 in a format that is compatible with the API of the D4 platform.

Distribution service container 36 is a software container that is executed by the processor (not shown) of the D4 platform to share the data saved in system status condition database 34 through second open interface 38 to the rest of network 10. Second open interface 38 can share the same API as first open interface 32 and can include a wireless transmitter and receiver for communication to network 10, or a port or plug for connection to a wireless transmitter and receiver. When second open interface 38 shares the same API as first open interface 32, the data being shared to network 10 by distribution service container 36 through second open interface 38 does not require reformatting. Distribution service container 36 includes synchronization module 37. Synchronization module 37 is a software module that automatically causes distribution service container 36 to share any data changes to the memory of system status condition database 34 to network 10 through second open interface 38. Thus, anytime data import service container 30 saves data from the sensors of physical asset 26 to system status condition database 34, synchronization module 37 will cause distribution service container 36 to automatically share that data with the other nodes of network 10 shown in FIG. 1. To share that data, distribution service container 36 instructs the wireless transmitter and receiver of second open interface 38 to transmit the data to network 10. Distribution service container 36 can also receive data from other nodes of network 10 and saves that data to the memory of system status condition database 34. In some examples, distribution service container 36 can send data received through second open interface 38 through data import service container 30 so that data import service container 30 can ensure the received data is in the correct format before the received data is saved to the memory of system status condition database 34. If the received data is not in the correct format, data import service container 30 can reformat or reorganize the received data before saving the received data to system status condition database 34.

Condition data transform service container 40 is a software container that is executed by the processor (not shown) of the D4 platform to retrieve data from system status condition database 34 and send the data through third open interface 42. Third open interface 42 can share the same API as first open interface 32 and second open interface 38. Third open interface 42 can include a plug or port for physical connection to user interface device 46 and monitoring and maintenance container 44. Third open interface 42 can also be configured for wireless connection to user interface device 46 and monitoring and maintenance container 44, such as through Bluetooth. Condition data transform service container 40 can reformat the data that condition data transform service container 40 retrieves from system status condition database 34 to be compatible with an API and software system of user interface device 46 and monitoring and maintenance container 44. User interface device 46 and/or monitoring and maintenance container 44 can communicate third-party troubleshooting plugin 50 to condition data transform service container 40 once user interface device 46 and monitoring and maintenance container 44 are in communication with third open interface 42. Third-party troubleshooting plugin 50 is software provided by the vendor of user interface device 46 and/or monitoring and maintenance container 44 that specifically aids condition data transform service container 40 in formatting the data that condition data transform service container 40 retrieves from system status condition database 34 to be compatible with the API and the software system of user interface device 46 and monitoring and maintenance container 44. Third-party troubleshooting plugin 50 can also allow condition data transform service container 40 to read data received by condition data transform service container 40 through third open interface 42 from user interface device 46 and monitoring and maintenance container 44. Condition data transform service container 40 can also reformat and reorganize data received through third open interface 42 from user interface device 46 and monitoring and maintenance container 44 before saving that data to system status condition database 34.

User interface device 46 can include a liquid crystal display (LCD), a light-emitting diode (LED) display, an organic light-emitting diode (OLED) display, or other display device suitable for providing information to users in graphical form. User interface device 46 can include graphical and/or physical control elements that enable user input to view and interact with monitoring and maintenance container 44 and/or the data stored in system status condition database 34. Monitoring and maintenance container 44 is a software container that can be stored in an internal memory of user interface device 46 and executed by a processor of user interface device 46 such that user interface device 46 and monitoring and maintenance container 44 form a single integrated device. Monitoring and maintenance container 44 can communicate with user interface device 46 through internal interface 51. In other examples, monitoring and maintenance container 44 can be stored on a separate device from user interface device 46 that is present at the same location as user interface device 46, the D4 platform of system node 12, and physical asset 26. Monitoring and maintenance container 44 comprises software that can analyze and process the data from system status condition database 34 to perform health diagnostics and monitoring of physical asset 26. The software of monitoring and maintenance container 44 can include machine learning algorithms that allow monitoring and maintenance container 44 to forecast the performance and maintenance needs of physical asset 26 based on the data from physical asset 26 saved in system status condition database 34. The analysis, forecasts, and results of the machine learning algorithms of monitoring and maintenance container 44 can be communicated through third open interface 42 to condition data transform service container 40, saved to system status condition database 34 by condition data transform service container 40, and shared through second open interface 38 to network 10 by distribution service container 36.

The machine learning algorithms of monitoring and maintenance container 44 can be proprietary and secret. To protect the machine learning algorithms of monitoring and maintenance container 44, monitoring and maintenance container 44 can include a firewall or unpublished API. Third-party troubleshooting plugin 50 can include instructions and/or permissions that enable the API of third open interface 42 and condition data transform service container 40 to communicate through the firewall and/or with the unpublished API of monitoring and maintenance container 44. In the event that physical asset 26 is at significant risk of imminent enemy capture, user interface device 46 and monitoring and maintenance container 44 can be unplugged and disconnected from third open interface of the D4 platform and transported to a safe location away from system node 12 to protect the machine learning algorithms of monitoring and maintenance container 44 from capture. The D4 platform can remain connected to physical asset 26 to continue monitoring physical asset 26 and continue sending data to network 10 up to the moment of capture and even after capture of physical asset 26. Alternatively, the D4 platform can be unplugged and disconnected from physical asset 26, or rendered useless, prior to capture of physical asset 26. As shown in FIG. 2B and discussed below, user interface device 46 can include additional databases and software service containers integrated into user interface device 46 to support physical asset 26 at system node 12.

FIG. 2B is a diagram of another example of system node 12 of network 10 with the D4 platform. In the example of FIG. 2B, user interface device 46 can further include technical manual (TM) listing 52, fault linked technical manuals (TMs) 54, technical manual (TM) library 56, supply display 58, line replaceable unit (LRU) part availability container 60, fourth open interface 62 to connect to third party application service 64, and supply data library 66. Default network adapter 68 and vendor network adapter 70 are also shown in FIG. 2B

As previously discussed with reference to FIG. 2A, second open interface 38 of the D4 platform can include a wireless transmitter and receiver for communication to network 10, or a port or plug for connection to a wireless transmitter and receiver. In some examples, such as the example of FIG. 2B, default network adapter 68 or vendor network adapter 70 may also be used to connect second open interface 38 to network 10. In examples where network 10 is supported by a third party, or multiple third parties, vendor network adapter 70 can be configured to interface the API and software platform of the D4 platform and system node 12 to a third party API and software platform that is supporting communication in network 10. For example, logistics support node 16, acquisition community node 18, OEM node 20, and training center node 22 of network 10 shown in FIG. 1 may each be operated by a third party with a distinct API and software platform from the D4 platform at system nodes 12 and relay nodes 14. Vendor network adapter 70 enables second open interface 38 of the D4 platform at system node 12 to communicate with these nodes to pass and receive information. In other examples, each of logistics support node 16, acquisition community node 18, OEM node 20, and training center node 22 of network 10 shown in FIG. 1 can each be outfitted with the D4 platform so that vendor network adapter 70 is not needed. In examples where network 10 is primarily supported by the D4 platform at each of system nodes 12 and relay nodes 14, default network adapter 68 can be plugged into second open interface 38 to connect system node 12 to an antenna for communication with network 10.

TM listing 52 is a list and/or menu of technical manuals relevant to physical asset 26 stored in TM library 56 in the memory of user interface device 46. The list of technical manuals can comprise manuals on maintenance of physical asset 26, usage instructions for physical asset 26, instructions to dispense armaments from physical asset 26, usage instructions for user interface 46 and monitoring and maintenance container 44, usage and maintenance instructions for the D4 platform, and/or other technical manuals which a person of skill in the art could find useful at system node 12. The technical manuals can be static documents and/or the technical manuals can be guided and dynamic. Dynamic technical manuals can change the information displayed to the user based on input from the user. TM library 56 can be prepopulated with all the technical manuals or TM library 56 can be populated by network 10 after user interface device 46 is connected to D4 platform 10. Over time, TM library can receive updates and additions from network 10 through the D4 platform.

Fault linked TMs 54 is a software microservice module that links technical manuals in TM library 56 relevant to addressing system faults of physical asset 26. Fault linked TMs 54 can then display training manual options on TM listing 52 that correlate best to a particular fault. As new faults are discovered in physical asset 26 at system node 12, or information regarding faults in other physical assets 26 at other system nodes 12 in network 10 is received through the D4 platform, fault linked TMs 54 can add new links to the technical manuals in TM library 56 and update TM listing 52. Training center node 22 and OEM node 20 (both shown in FIG. 1) can also send information updates to fault linked TMs 54 through network 10 and the D4 platform of system node 12. Fault linked TMs 54 can be improved and refined by machine learning, data trending, and human intervention based on data stored in system status condition database 34 and from user feedback.

Supply display 58 can display all of line replaceable unit (LRU) components that can be available for repair, maintenance, and supplying of physical asset 26 at system node 12. Supply display 58 can interact with and show information from LRU part availability container 60, fourth open interface 62, third party application service 64, and supply data library 66. Third party application service 64 can be a third-party supplier database of LRU components for physical asset 26 managed by a third-party vendor. LRU part availability container 60 is a software container that can connect with and communicate with third party application service 64 through fourth open interface 62 to acquire information regarding availability of LRU components for physical asset 26 at system node 12. LRU part availability container 60 can save information and data from third party application service 64 locally to supply data library 66. By saving the information and data from third party application service 64 locally to supply data library 66, supply display 58 and LRU part availability container 60 can access that information and data from supply data library 66 when fourth open interface 62 is not connected to third party application service 64.

Supply data library 66 locally stores in memory data regarding the supply of LRU component received by system node 12. The data can be from LRU part availability container 60, third party application service 64, or from system status condition database 34. LRU part availability container 60 can alter which LRU components are displayed on supply display 58. Specifically, if a component is not in stock and is not expected to be restocked, the component can be removed from supply display 58 on user interface device 46. Supply display 58 displayed on user interface device 46 can be altered and influenced by data stored on system status condition database 34. If a fault occurs in physical asset 26 at system node 12, or a fault occurs on another physical asset 26 at another system node 12, supply display 58 can receive the fault from system status condition database 34 through condition data transform service 44 and third open interface 42. Supply display 58 can then display which LRU components correlate best to that fault. Supply display 58 can display a current availability of an LRU component, such as a number of components and their locations, as well as the expected lead time and logistics of acquiring that LRU component. Specifically, LRU part availability container 60 can calculate an expected date and time of arrival and communicate that information to supply display 58 which can display that information to a user interacting with user interface device 46. Third party application service 64 can communicate a component availability through fourth open interface 62 to update supply data library 66.

Third party application service 64 can also query the as-built product information of physical asset 26, technical manuals of TM library 56, and part supply data from supply data library 66 to determine the appropriate parts to display in supply display 58 and/or preemptively order components for upcoming maintenance requirements. If fourth open interface 62 is disconnected from third party application service 64 and unable to connect to third party application service 64 to request a component or information regarding a component, LRU part availability container 60 can send a communication through third open interface 42 of the D4 platform, and the D4 platform can send the communication through distribution service container and second open interface 38 to network 10. Network 10 can forward the communication to third party application service 64 via acquisition community node 18 shown in FIG. 1. Network 10 can send information and updates back to LRU part availability container 60 and supply data library 66 through second open interface 38, distribution service container 36, system status condition database 34, condition data transform service container 40, and second open interface 42 of the D4 platform.

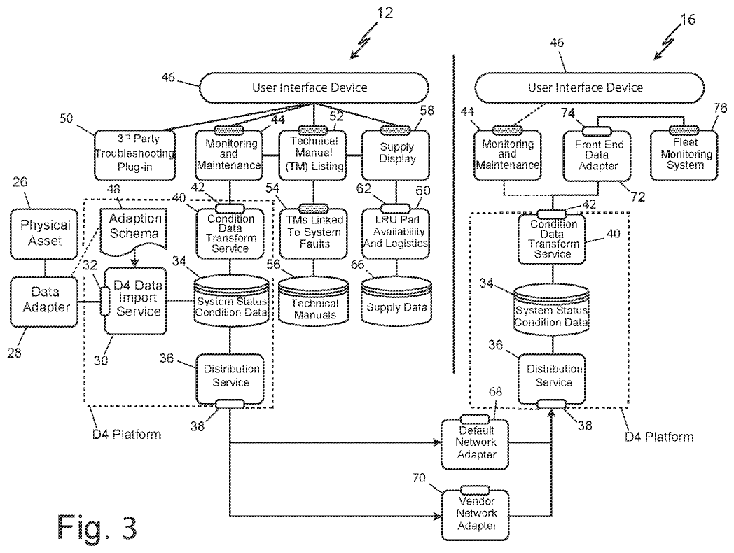

With user interface device 46 and the D4 platform together at system node 12, health monitoring of physical asset 26 can be performed in location of physical asset 26 using monitoring and maintenance container 44 of user interface device 46 and the data collected into system status condition database 34 of the D4 platform from physical asset 26. User interface device 46 also provides training support and maintenance support locally for physical asset 26 without the need of additional third party devices. As discussed below with reference to FIG. 3, health monitoring of system node 12 can also be performed remotely from system node 12 by other nodes in network 10.

FIG. 3 is a diagram of system node 12 from FIG. 2B connected to logistics support node 16. Logistics support node 16 is at a different physical location from system node 12 and physical asset 26. As shown in FIG. 3, logistics support node 16 also includes the D4 platform and user interface device 46. The D4 platform at logistics support node 16 is a twin device to the D4 platform at system node 12. Though FIG. 3 does not show all of the features and services of user interface device 46 at logistics support node 16, user interface device 46 at logistics support node 16 can include all of the same features and services as user interface device 46 at system node 12. Distribution service container 36 and second open interface 38 of system node 12 are in communication with distribution service container 36 and second open interface 38 of logistics support node 16. Data from physical asset 26 that is saved to system status condition database 34 at system node 12 is automatically forwarded by distribution service container 36 to logistics support node 16 through second open interface 38 of system node 12. The data from the physical asset 26 sent to logistics support node 16 from system node 12 is received through second open interface 38 of logistics support node 16 and saved to system status condition database 34 of logistics support node 16 by distribution service container 36 of logistics support node 16.

To perform health monitoring and diagnostics of physical asset 26 at logistics support node 16, monitoring and maintenance container 44 of user interface device 46 at logistics support node 16 accesses the data from physical asset 26 saved to system status condition database 34 of logistics support node 16 through third open interface 42 and condition data transform service container 40 at logistics support node 16. Monitoring and maintenance container 44 at logistics support node 16 can output the results of the health monitoring and diagnostics of physical asset 26 to a display of user interface device 46 and to third open interface 42 and condition data transform service container 44 at logistics support node 16. Condition data transform service container 44 saves the results of the health monitoring and diagnostics of physical asset 26 to system status condition database 34 at logistics support node 16. Distribution service container 36 can automatically forward any information and data saved to system status condition database 34 to the D4 platform at system node 12, including the results of the health monitoring and diagnostics of physical asset determined at logistics support node 16. In this manner, the information and data saved in system status condition database 34 at logistics support node 16 is continually synchronized with the information and data saved in system status condition database 34 at system node 12. If user interface device 46 at system node 12 becomes inoperable and unable to perform health monitoring of physical asset 26 locally at system node 12, logistics support node 16 can overcome that deficiency by remotely performing health monitoring of physical asset 26. If the D4 platform at system node 12 becomes disconnected with the D4 platform at logistics support node 16, logistics support node 16 can use the most recent information regarding physical asset 26 saved to system status condition database 34 at logistics support node 16 to evaluate the health, condition, and position of physical asset 26.

As shown in FIG. 3, fleet monitoring system 76 at logistics support node 16 can be connected to third open interface 42 of the D4 platform at logistics support node 16 by front end data adapter 72. Fleet monitoring system 76 can be a third-party system for monitoring and coordinating a fleet of physical assets and personnel. Front end data adapter 72 connects to fleet monitoring system 76 through fifth open interface 74. Front end data adapter 72 adapts data from condition data transform service container 44 to be readable by fleet monitoring system 76 and converts data from fleet monitoring system 76 to be readable by condition data transform service container 44. Fleet monitoring system 76 can use information from system status condition database 34 of logistics support node 16 to schedule missions, coordinate maintenance operations, and support for physical asset 26.

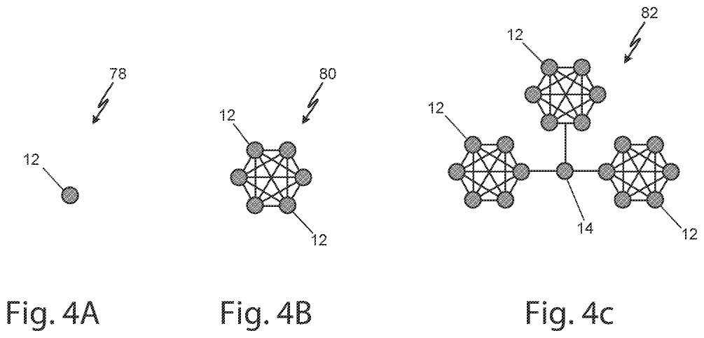

FIGS. 4A-4C illustrate alternative system node 12 groupings and will be discussed together. FIG. 4A is a diagram of single system node 12 operating in localized mode 78. FIG. 4B is a diagram of a plurality of system nodes 12 forming a distributed mesh 80. FIG. 4C is a diagram of multiple meshes of nodes 12 connected by relay node 14 into centralized mesh 82.

In localized mode 78, system node 12 is operating independently from and unconnected to a larger mesh of nodes 12. In localized mode 78, system node 12 can be disconnected from logistics support node 16, acquisition community node 18, OEM node 20, or training center 22 of network 10 shown in FIG. 1. If system node 12 comprises physical asset 26, all data produced by physical asset 26 can be stored locally in the D4 platform of system node 12 and analyzed locally by user interface device 46 discussed above with reference to FIGS. 2A and 2B. System node 12 can operate in localized mode 78 if a connection to other nodes has been severed or if a connection to outside nodes is not desired to maintain stealth operations. The connection to other nodes can be severed due to a destruction of relay node 14, disconnection of relay node 14, or any other operation that would disconnect or deactivate relay node 14.

The plurality of system nodes in distributed mesh 80 are directly connected together by the respective D4 platforms of each system node 12 in the plurality of system nodes 12. Each system node 12 in distributed mesh 80 is connected to a physical asset. In distributed mesh 80, the plurality of system nodes 12 are synchronized such that any data generated at one system node 12 is automatically shared and saved to the rest of the plurality of system nodes 12. Since data and information in the plurality of system nodes 12 in FIG. 4B is synchronized across every system node 12, health monitoring for any physical asset connected to any system node 12 in distributed mesh 80 can be performed by any system node 12 in distributed mesh 80. If any single system node 12 is disconnected from the plurality of system nodes 12 in distributed mesh 80, the information and data from that single system node 12 at the moment of disconnection is saved within the D4 platforms of the rest of the plurality of system nodes 12. So long as at least one system node 12 exists in distributed mesh 80, the information and data regarding every physical asset that is or was connected to the plurality of system nodes 12 is saved and preserved. There is no single point of failure for the network formed by the plurality of system nodes 12 in distributed mesh 80. Data is not lost if a single system node 12 is destroyed. Further, the data synchronization of the plurality of system nodes 12 slows the plurality of system nodes to share environmental visibility and alerting.

In centralized mesh 82 of FIG. 4C, relay node 14 can connect multiple distributed meshes 80. Relay node 14 can synchronize the distributed meshes 80 such that the data stored on any individual system node 12 can be the same as any other system node 12 in centralized mesh 82. The data stored on any individual system node 12 can be accessible by every other system node 12 in centralized mesh 82. Furthermore, analysis of the data on any system node 12 can be analyzed at any other system node 12. Furthermore, each distributed mesh 80 of centralized mesh 82 can be a segregated network that can be inter-operable with other distributed meshes 80 on centralized mesh 82. The segregated network can have cross-domain solutions across D4 platform 10 that enable customer specific integration opportunities on each segregated network.

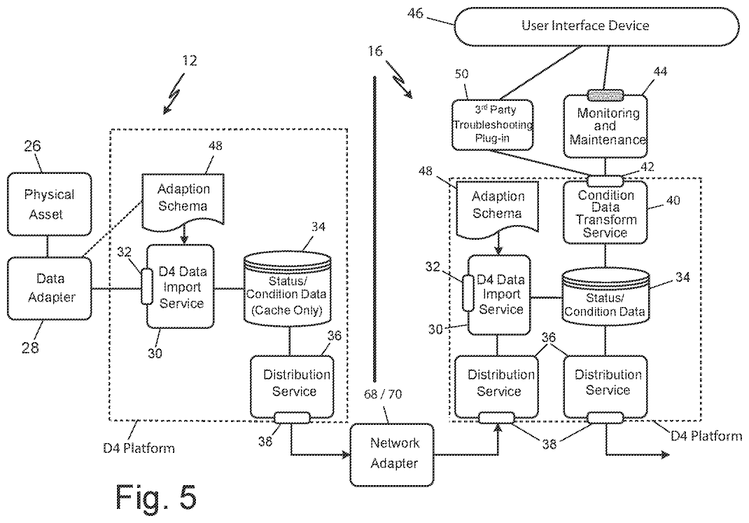

FIG. 5 is a diagram of another example of system node 12 in communication with logistics support node 16. In the example of FIG. 5, system node 12 includes physical asset 26 in communication with first open interface 32 of the D4 platform as described above with reference to FIG. 2A. Second open interface 38 of the D4 platform of system node 12 is in communication with second open interface 38 of logistics support node 16. In the example of FIG. 5, physical asset 26 and system node 12 is deployed to an unsecure and unsafe location. To reduce the risk of comprising the sensitive machine learning algorithms of monitoring and maintenance container 44 of user interface device 46 and any other significant information stored on user interface device 46, system node 12 does not include user interface device 46. Rather, system status condition database 34 of the D4 platform of system node 12 is set to a cache mode such that data received by system status condition database 34 is only saved in system status condition database 34 long enough to transfer the data through distribution service container 36 and second open interface 38 of system node 12 to logistics support node 16. After the data has been sent from system node 12 to system status condition database 34 of the D4 platform of logistics support node 16, the data is cleared from system status condition database 34 of the D4 platform of system node 12. Thus, if physical asset 26 is captured, no sensitive data is present on the D4 platform of system node 12.

At logistics support node 16, which is at a safer and more secure location than system node 12, user interface device 46 is connected to third open interface 42 of the D4 platform of logistics support node 16. Monitoring and maintenance container 44 of user interface device 46 can perform health monitoring and diagnostics of physical asset 26. To perform health monitoring and diagnostics of physical asset 26 at logistics support node 16, monitoring and maintenance container 44 of user interface device 46 at logistics support node 16 accesses the data from physical asset 26 saved to system status condition database 34 of logistics support node 16 through third open interface 42 and condition data transform service container 40 at logistics support node 16. Monitoring and maintenance container 44 at logistics support node 16 can output the results of the health monitoring and diagnostics of physical asset 26 to a display of user interface device 46 and to third open interface 42 and condition data transform service container 44 at logistics support node 16. Condition data transform service container 44 saves the results of the health monitoring and diagnostics of physical asset 26 to system status condition database 34 at logistics support node 16. Distribution service container 36 can automatically forward any information and data saved to system status condition database 34 to other safe and secure nodes in communication with logistics support node 16.

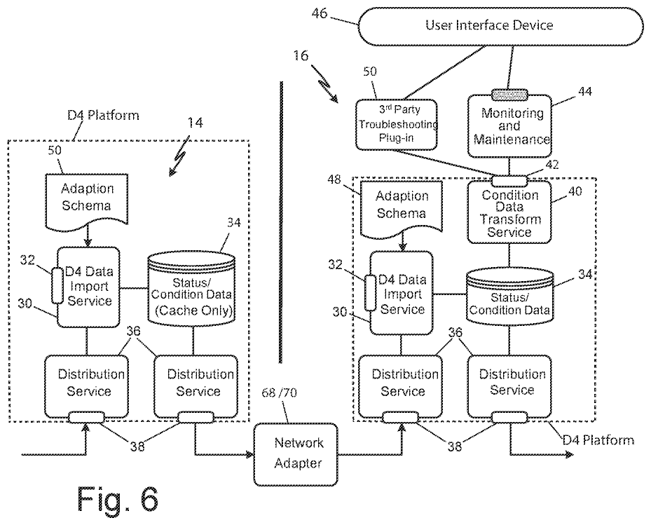

FIG. 6 is a diagram of relay node 14 in communication with logistics support node 16. Relay node 14 can be in communication with at least one system node 12 (not shown). As shown in the example of FIG. 6, both relay node 14 and logistics support node 16 each include the D4 platform. Second open interface 38 of the D4 platform of relay node 14 is in communication with second open interface 38 of the D4 platform of logistics support node 16. Similar to the example of system node 12 described above with reference to FIG. 5, relay node 14 does not save for long term any data in system status condition database 34 of the D4 platform of relay node 14. System status condition database 34 of the D4 platform of relay node 14 is set to a cache mode such that data received by system status condition database 34 of relay node 14 is only saved in system status condition database 34 of relay node 14 long enough to transfer the data through distribution service container 36 and second open interface 38 of relay node 14 to logistics support node 16. After the data has been sent from relay node 14 to system status condition database 34 of the D4 platform of logistics support node 16, the data is cleared from system status condition database 34 of the D4 platform of relay node 14. Thus, if relay node 14 is captured, no sensitive data is present on the D4 platform of relay node 14.

At logistics support node 16, which is at a safer and more secure location than relay node 14, user interface device 46 is connected to third open interface 42 of the D4 platform of logistics support node 16. Monitoring and maintenance container 44 of user interface device 46 can perform health monitoring and diagnostics of any physical asset whose information was passed to logistics support node 16 through relay node 14. Logistics support node 16 performs the health monitoring and diagnostics as described above with reference to FIG. 5.

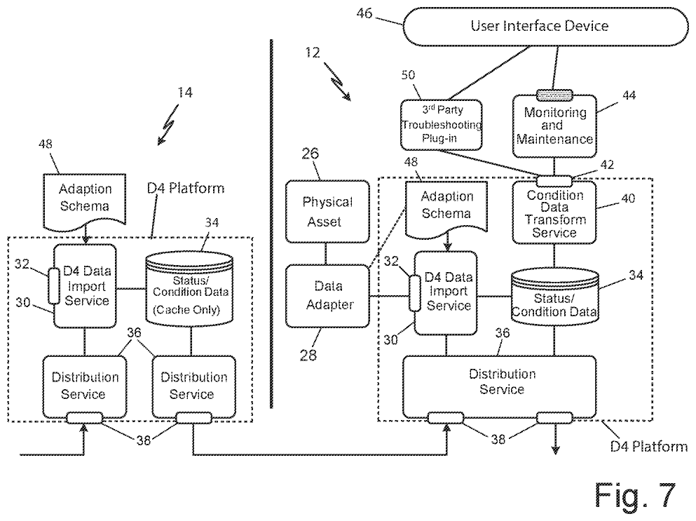

FIG. 7 is a diagram of relay node 14 in communication with system node 12. As shown in the example of FIG. 6, both relay node 14 and system node 12 each include the D4 platform. Second open interface 38 of the D4 platform of relay node 14 is in communication with second open interface 38 of the D4 platform of system node 12. Similar to relay node 14 described above with reference to FIG. 6, relay node 14 shown in FIG. 7 does not save for long term any data in system status condition database 34 of the D4 platform of relay node 14. System status condition database 34 of the D4 platform of relay node 14 is set to a cache mode such that data received by system status condition database 34 of relay node 14 is only saved in system status condition database 34 of relay node 14 long enough to transfer the data through distribution service container 36 and second open interface 38 of relay node 14 to system node 12. After the data has been sent from relay node 14 to system status condition database 34 of the D4 platform of system node 12, the data is cleared from system status condition database 34 of the D4 platform of relay node 14. Thus, if relay node 14 is captured, no sensitive data is present on the D4 platform of relay node 14.

At system node 12, user interface device 46 is connected to third open interface 42 of the D4 platform of system node 12. Monitoring and maintenance container 44 of user interface device 46 can perform health monitoring and diagnostics of any physical asset whose information was passed to system node 12 through relay node 14 in addition to performing health monitoring and diagnostics for physical asset 26 connected to system node 12. System node 12 can also pass information and data regarding physical asset 26 at system node 12 to relay node 14.

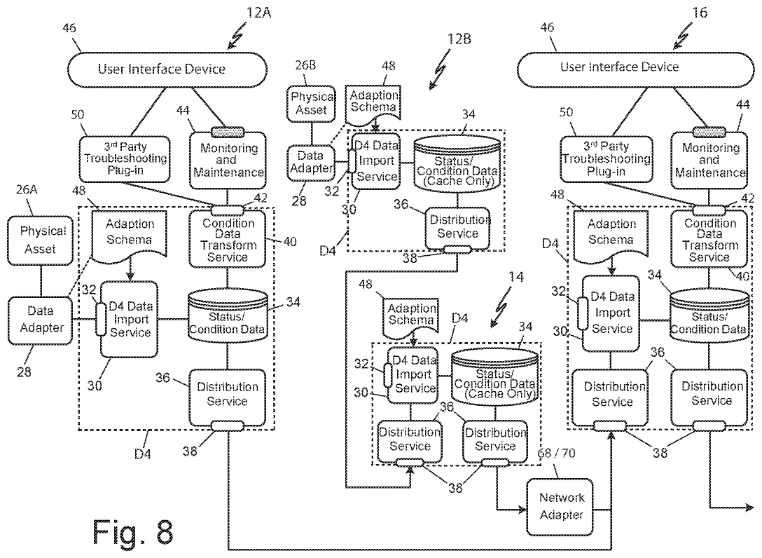

FIG. 8 is a diagram of logistics support node 16 in communication with first system node 12A and relay node 14, and second system node 12B in communication with relay node 14. In the example of FIG. 8, first system node 12A is connected to first physical asset 26A and collecting data from sensors on first physical asset 26A as described above with reference to FIG. 2A. First system node 12A is in a safe location, so first system node 12A includes user interface device 46 on site to locally perform health monitoring for first physical asset 26A using the proprietary machine learning algorithms of monitoring and maintenance container 44 of user interface device 46. Similar to the example of FIG. 2A, the D4 platform of first system node 12A can automatically forward and share the data and information regarding first physical asset 26A collected at first system node 12A to logistics support node 16. Similar to the description of FIG. 3, logistics support node 16 can use the data and information regarding first physical asset 26A to remotely monitor first physical asset 26A and remotely perform health monitoring for first physical asset 26A.

Second system node 12B is similar to the example of system node 12 described above with reference to FIG. 5. Second system node 12B is connected to second physical asset 26B and is in a location that unsecure and susceptible to capture. To prevent capture of the machine learning algorithms in monitoring and maintenance container 44 of user interface device 46, second system node 12B does not include user interface device 46. Health monitoring for second physical asset 26B is performed remotely from second system node 12 by logistics support node 16 and/or by first system node 12A. The D4 platform of second system node 12B collects data regarding second physical asset 26B and forwards the data regarding second physical asset 26B to the D4 platform of relay node 14. The D4 platform of relay node 14 forwards the data regarding second physical asset 26B to logistics support node 16 in a manner similar to the description of FIG. 6. Relay node 14 can also forward the data regarding second physical asset 26B to first system node 12A, or logistics support node 16 can forward the data regarding second physical asset 26B to first system node 12A. The data regarding second physical asset 26B is cleared from the memory of system status condition database 34 of second system node 12B and the memory of system status condition database 34 of relay node 14 after the data regarding second physical asset 26B has been received by logistics support node 16 and/or first system node 12A.

### Discussion of Possible Embodiments

The following are non-exclusive descriptions of possible embodiments of the present invention.

In one embodiment, a network includes a first node. The first node includes a data import service container, a system status condition database, and a distribution service container. The data import service container includes a first open interface and is configured to receive and organize data from the first open interface. The system status condition database is connected to the data import service container and includes memory for storing the data received and organized by the data import service container. The distribution service container is connected to the system status condition database and includes a second open interface for connecting the first node to a distribution service container of a second node of the network. The distribution service container of the first node is configured to synchronize the system status condition database of the first node with a system status condition database of the second node.

The network of the preceding paragraph can optionally include, additionally and/or alternatively, any one or more of the following features, configurations and/or additional components:
an adaptation schema container connected to the data import service container, wherein an adaptation schema stored in the adaptation schema container is configured to instruct the data import service container on a format for the organization of the data from the vendor;
a condition data transform service container connected to the system status condition database, wherein the condition data transform service container comprises a third open interface for plug-in connection or wireless connection to a user interface device;
a third-party troubleshooting plugin connected to the third open interface, wherein the third-party troubleshooting plugin enables the user interface device to access the data saved in the memory of the system status condition database;
the user interface device comprises: a monitoring and maintenance container connected to the third open interface, wherein the monitoring and maintenance container is configured to perform health monitoring, prognostics, and/or machine learning on the data saved in the memory of the system status condition database; and a user display in communication with the monitoring and maintenance container;
a second distribution service container connected to the data import service container of the first node and comprising a fourth open interface for connecting the first node to the second node or a third node of the network, wherein the second distribution service container is configured to receive data from the second node or the third node, and wherein the distribution service container of the first node is configured to send data from the system status condition database of the first node to the second node;
the first open interface is connected to a vendor provided data adapter which is connected to a deployable physical asset, and wherein the data import service container is configured to receive and organize data from the vendor provided data adapter;
the distribution service container of the first node is also connected to the data import service container of the first node, wherein the distribution service container of the first node is configured to direct data from the second node and/or a third node into the data import service container of the first node via the second open interface, and wherein the distribution service container of the first node is configured to send data from the system status condition database of the first node to the second node and/or the third node via the second open interface; and/or
the data import service container, the first open interface, the system status condition database, the distribution service container, the second open interface, the condition data transform service container, and the third open interface of the first node are all within a single

In another embodiment, a method for monitoring a physical asset includes collecting data on the physical asset via a sensor and directing the data across a first open interface of a data delivery platform device and into a data import service container of the data delivery platform device. The method further includes applying an adaption schema to the data in the data import service container and directing the data from the data import service container to a system status condition database of the data delivery platform device where the data is saved locally to memory in the data delivery platform device at the location of the physical asset.

The method of the preceding paragraph can optionally include, additionally and/or alternatively, any one or more of the following features, configurations and/or additional components:
directing the data from the system status condition database to a distribution service container of the data delivery platform device connected to the system status condition database at the location of the physical asset, wherein the distribution service container comprises a second open interface for wireless connection to a remote node at a second location, wherein the second location and the location of the physical asset are different; transferring the data wirelessly from the second open interface to the remote node; and processing the data through health monitoring and/or diagnostics applications at the remote node;
sending data from the remote node to the distribution service container and the system status condition database to synchronize the data stored on the remote node with the data stored on the system status condition database of the data delivery platform device;
directing the data from the system status condition database to a condition data transform service container of the data delivery platform device connected to the system status condition database at the location of the physical asset, wherein the condition data transform service container comprises a third open interface; transforming the data from the system status condition database via the condition data transform service container; transferring the transformed data across the third open interface of the data delivery platform to a user interface device plugged-in or wirelessly connected to the third open interface at the location of the physical asset; and delivering the transformed data to health monitoring and/or diagnostics applications on the user interface device at the location of the physical asset;
directing the data from the system status condition database to a distribution service container of the data delivery platform device connected to the system status condition database at the location of the physical asset, wherein the distribution service container comprises a second open interface for wireless connection to a relay node at a relay location, wherein the relay location and the location of the physical asset are different; and transferring the data wirelessly from the second open interface to the relay node of the data delivery platform;
transferring the data wirelessly from the relay node to a remote node at a remote location, wherein the remote location is different from the relay location and the location of the physical asset; clearing the data from a memory of the relay node after the data is transferred wirelessly from the relay node to the remote node; and processing the data through health monitoring and/or diagnostics applications at the remote node; and/or
the relay node is a second data delivery platform device carried by one of an aerial drone, a ground vehicle, an aerial vehicle, a ship, a space satellite, a computer in a fixed facility, a person with portable communication equipment, or any other system or object used for electronic data communication.

In another embodiment, a system is disclosed that includes a first device. The first device includes a data import service container with a first open interface. The data import service container is configured to receive and organize data from the first open interface. The first device also includes a system status condition database connected to the data import service container. The system status condition database includes memory for storing the data received and organized by the data import service container. A distribution service container is connected to the system status condition database and includes a second open interface and a synchronization module configured to automatically share the data stored in the memory of the system status condition database across the second open interface. The first device also includes a condition data transformation service container connected to the system status condition database. The condition data transformation service container includes a third open interface.

The system of the preceding paragraph can optionally include, additionally and/or alternatively, any one or more of the following features, configurations and/or additional components:
a second device comprising: a monitoring and maintenance container configured to communicate with the third open interface, wherein the monitoring and maintenance container is configured to perform health monitoring, prognostics, and/or machine learning on the data saved in the memory of the system status condition database; and a user display in communication with the monitoring and maintenance container;
the first open interface, the second open interface, and the third open interface share the same application programming interface; and/or
the first open interface, the second open interface, and the third open interface each comprise at least one of a plug, a port, a wireless receiver, and a wireless transmitter.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A network comprising:
a first node comprising:
a data import service container comprising a first open interface, wherein the data import service container is configured to receive and organize data from the first open interface;
a system status condition database connected to the data import service container, wherein the system status condition database comprises memory for storing the data received and organized by the data import service container; and
a distribution service container connected to the system status condition database, wherein the distribution service container comprises a second open interface for connecting the first node to a distribution service container of a second node of the network, wherein the distribution service container of the first node is configured to synchronize the system status condition database of the first node with a system status condition database of the second node.

2. The network of claim 1, further comprising an adaptation schema container connected to the data import service container, wherein an adaptation schema stored in the adaptation schema container is configured to instruct the data import service container on a format for the organization of the data from the vendor.

3. The network of claim 1, further comprising a condition data transform service container connected to the system status condition database, wherein the condition data transform service container comprises a third open interface for plug-in connection or wireless connection to a user interface device.

4. The network of claim 3, further comprising a third-party troubleshooting plugin connected to the third open interface, wherein the third-party troubleshooting plugin enables the user interface device to access the data saved in the memory of the system status condition database.

5. The network of claim 3, wherein the user interface device comprises:
a monitoring and maintenance container connected to the third open interface, wherein the monitoring and maintenance container is configured to perform health monitoring, prognostics, and/or machine learning on the data saved in the memory of the system status condition database; and
a user display in communication with the monitoring and maintenance container.

6. The network of claim 3, further comprising:
a second distribution service container connected to the data import service container of the first node and comprising a fourth open interface for connecting the first node to the second node or a third node of the network,
wherein the second distribution service container is configured to receive data from the second node or the third node, and
wherein the distribution service container of the first node is configured to send data from the system status condition database of the first node to the second node.

7. The network of claim 1, wherein the first open interface is connected to a vendor provided data adapter which is connected to a deployable physical asset, and wherein the data import service container is configured to receive and organize data from the vendor provided data adapter.

8. The network of claim 1, wherein the distribution service container of the first node is also connected to the data import service container of the first node, wherein the distribution service container of the first node is configured to direct data from the second node and/or a third node into the data import service container of the first node via the second open interface, and wherein the distribution service container of the first node is configured to send data from the system status condition database of the first node to the second node and/or the third node via the second open interface.

9. The network of claim 3, wherein the data import service container, the first open interface, the system status condition database, the distribution service container, the second open interface, the condition data transform service container, and the third open interface of the first node are all within a single device.

10. A method for monitoring a physical asset, wherein the method comprises:
collecting data on the physical asset via a sensor;
directing the data across a first open interface of a data delivery platform device and into a data import service container of the data delivery platform device;
applying an adaption schema to the data in the data import service container; and
directing the data from the data import service container to a system status condition database of the data delivery platform device where the data is saved locally to memory in the data delivery platform device at the location of the physical asset.

11. The method of claim 10, further comprising:
directing the data from the system status condition database to a distribution service container of the data delivery platform device connected to the system status condition database at the location of the physical asset, wherein the distribution service container comprises a second open interface for wireless connection to a remote node at a second location, wherein the second location and the location of the physical asset are different;
transferring the data wirelessly from the second open interface to the remote node; and
processing the data through health monitoring and/or diagnostics applications at the remote node.

12. The method of claim 11, further comprising:
sending data from the remote node to the distribution service container and the system status condition database to synchronize the data stored on the remote node with the data stored on the system status condition database of the data delivery platform device.

13. The method of claim 12, further comprising:
directing the data from the system status condition database to a condition data transform service container of the data delivery platform device connected to the system status condition database at the location of the physical asset, wherein the condition data transform service container comprises a third open interface;
transforming the data from the system status condition database via the condition data transform service container;
transferring the transformed data across the third open interface of the data delivery platform to a user interface device plugged-in or wirelessly connected to the third open interface at the location of the physical asset; and
delivering the transformed data to health monitoring and/or diagnostics applications on the user interface device at the location of the physical asset.

14. The method of claim 10, further comprising:
directing the data from the system status condition database to a distribution service container of the data delivery platform device connected to the system status condition database at the location of the physical asset, wherein the distribution service container comprises a second open interface for wireless connection to a relay node at a relay location, wherein the relay location and the location of the physical asset are different; and
transferring the data wirelessly from the second open interface to the relay node of the data delivery platform.

15. The method of claim 14, further comprising:
transferring the data wirelessly from the relay node to a remote node at a remote location, wherein the remote location is different from the relay location and the location of the physical asset;
clearing the data from a memory of the relay node after the data is transferred wirelessly from the relay node to the remote node; and
processing the data through health monitoring and/or diagnostics applications at the remote node.

16. The method of claim 15, wherein the relay node is a second data delivery platform device carried by one of an aerial drone, a ground vehicle, an aerial vehicle, a ship, a space satellite, a computer in a fixed facility, a person with portable communication equipment, or any other system or object used for electronic data communication.

17. A system comprising:
a first device comprising:
a data import service container comprising a first open interface, wherein the data import service container is configured to receive and organize data from the first open interface;
a system status condition database connected to the data import service container, wherein the system status condition database comprises memory for storing the data received and organized by the data import service container; and
a distribution service container connected to the system status condition database, wherein the distribution service container comprises a second open interface and a synchronization module configured to automatically share the data stored in the memory of the system status condition database across the second open interface; and
a condition data transformation service container connected to the system status condition database, wherein the condition data transformation service container comprises a third open interface.

18. The system of claim 17 further comprising:
a second device comprising:
a monitoring and maintenance container configured to communicate with the third open interface, wherein the monitoring and maintenance container is configured to perform health monitoring, prognostics, and/or machine learning on the data saved in the memory of the system status condition database; and
a user display in communication with the monitoring and maintenance container.

19. The system of claim 17, wherein the first open interface, the second open interface, and the third open interface share the same application programming interface.

20. The system of claim 19, wherein the first open interface, the second open interface, and the third open interface each comprise at least one of a plug, a port, a wireless receiver, and a wireless transmitter.
